(19) United States
(12) Patent Application Publication
(10) Pub. No.: US 2014/0344052 A1
(43) Pub. Date: Nov. 20, 2014

(54) Method for Presenting an Offer Over a Network

(71) Applicant: The Procter & Gamble Company, Cincinnati, OH (US)

(72) Inventors: Natalya K. Seals, Cincinnati, OH (US); Kanishka Das, Mason, OH (US); Silvia Cerolini, London (GB)

(73) Assignee: The Procter & Gamble Company, Cincinnati, OH (US)

(21) Appl. No.: 13/896,353

(22) Filed: May 17, 2013

(51) Int. Cl. G06Q 30/02

(52) U.S. Cl. CPC G06Q 30/0253; G06Q 30/0269
USPC 705/14.51

(57) ABSTRACT

A method includes: receiving notice, via a communications network that a member of a particular market demographic is shopping on-line; analyzing on-line and/or off-line shopping basket content information associated with the market demographic, according to consumer benefit(s) of a product market category of the contents; identifying a consumer need of the market demographic according to the analyzed consumer benefit(s); and communicating information, associated with products or services related to the consumer need, via an electronic communications network, to the market demographic member.

### FIELD OF THE INVENTION

The invention relates to the field of on-line sales. The invention relates particularly to the creation and presentation of a particularized offer to an on-line shopper.

### BACKGROUND OF THE INVENTION

On-line retail experiences utilizing the internet are well known in the art. On-line behavioral advertising, which takes account of past browsing behavior in the serving of ads during a contemporaneous browsing session, as well as on-line retail presentation of goods and/or services related to items and/or services currently being considered via browsing, currently in a shopper's on-line cart, or recently purchased items, are also known.

These methods seek to fully exploit the past behavior of the shopper as it relates to on-line retail offering. The methods do not offer much in terms of offering shoppers insightful expansions of the on-line experience including offers tailored for the shopper, not from the limited perspective of past behavior, but from an analysis of activities to identify unmet needs which may be satisfied via the consumer benefits associated with particular products.

What is needed is a method for defining and presenting on-line shoppers with offers tailored to meet their current, yet unmet needs. In some cases, meeting needs which the shopper/consumer was unaware existed. Offers which may expand the marketplace in terms of product category synergies and may, therefore more fully exploit the advantage on-line retail enjoys in comparison to so called, brick-and-mortar retail where product and category selections are limited by the physical extent of the particular locations.

### SUMMARY OF THE INVENTION

In one aspect, a method for presenting an offer, including steps of: receiving, via a communications network, on-line shopping basket content information associated with an on-line shopper; analyzing the on-line shopping basket content information according to the product market categories of the shopping basket contents; determining a market demographic from the analysis of the on-line shopping basket; analyzing off-line shopping basket content information associated with the market demographic, according to the product market categories of the contents; identifying a consumer need of the on-line shopper; and communicating, via an electronic communications network, information, associated with products or services related to the consumer need, to the on-line shopper.

In one aspect the method includes: receiving notice, via a communications network that a member of a particular market demographic is shopping on-line; analyzing on-line and/or off-line shopping basket content information associated with the market demographic, according to consumer benefit(s) of a product market category of the content; identifying a consumer need of the market demographic according to the analyzed consumer benefit(s); and communicating information, associated with products or services related to the consumer need, via an electronic communications network, to the market demographic member.

### DETAILED DESCRIPTION OF THE INVENTION

All examples provided herein are intended to add clarity to the overall description of the invention. No example should be interpreted as in any way limiting the invention or any aspect thereof.

As used herein the term communications network is applied expansively to include communications utilizing content from the internet as well as wireless networks such as cellular telephone networks and wired networks, including cable and telephone communications networks.

The term on-line shopper is used herein to refer to an individual or group utilizing a communications network to browse and/or purchase goods and/or services.

As used herein the term on-line shopping basket and on-line shopping basket contents are used interchangeably to refer to goods and/or services under consideration for purchase by an on-line shopper.

As used herein the terms product categories, product segments, and market categories are used to refer to identified market product segments. The product segments may be broad—cleaning, or narrow, scented liquid laundry detergent.

As used herein the term: ‘market demographic’ refers to respective segmentations of the participants of the consumer goods and/or services markets. Market participants may be segmented into respective demographics according to any factor which provides a point of differentiation. Exemplary demographics include, gender, geographic region, household composition, life stage.

As used herein the term: ‘consumer benefit’ refers to the underlying reason a product is used. Laundry detergent is used to provide the consumer benefit of clean clothing, pet food is used for the consumer benefit of a well nourished pet.

As used herein, the term: ‘consumer need’ is used to refer to a broader conceptual need which the consumer benefit of a product is used to help address. As an example, a consumer may have a need to present themselves in public in a particular manner. A portion of that need may revolve around the appearance of their clothing, and may in particular relate to a need to wear clean, well cared for garments. A portion of this consumer need may be addressed through the utilization of products which gently but effectively clean the consumers clothing.

In one aspect an execution of the method commences with the receipt, via a communications network, of a notice that there appears to be a member of a particular market demographic shopping on-line. This appearance may be created at an on-line retailer in a number of ways. Input associated with on-line behavioral advertising may indicate particular preferences of an on-line shopper aligned with the preferences of the market demographic of interest. Cookies, placed upon the computer of the on-line shopper by either the on-line retailer, or other parties may also be used as indicative of membership in the particular market demographic. Search engine use history, as well as public information available from the on-line shopper's participation in social networks may be used to provide information to a profile of the shopper indicative of demographic membership. Past shopping experiences and purchases of the on-line shopper may also be accessed by the on-line retailer and used to categorize the shopper as a member of one or more market demographics. Once the membership of the shopper has been determined, notice may be sent to interested parties that a prospective shopper with a market demographic membership of interest is presently shopping at the site of the on-line retailer. The notice may be accompanied by information relating to the current contents of the on-line shopping cart of the shopper, or this information may be held in confidence by the on-line retailer.

Upon receipt of the notice, the marketer, or other interested party, may refer to analyses of the market conducted previously and relevant to the particular market demographic. Such analyses may be conducted as follows, utilizing aggregated market basket data, available from the Nielsen Company, of Cincinnati, Ohio, as well as Kantar Media of Boston, Mass. The aggregated data may be analyzed to identify product categories which are correlated in the baskets of the members of the demographic. The correlated product categories may subsequently be analyzed to determine the consumer benefits associated with the products within the categories, as well as the underlying consumer needs associated with those consumer benefits individually and in combination as more than a single benefit may be necessarily combined to satisfactorily meet an underlying consumer need.

After the underlying consumer need(s) associated with the product categories of the carts of the demographic are identified, product categories, and/or specific products which provide an alternative approach to addressing the consumer need, or offer a more complete means of addressing the consumer need may be identified. These products and/or product categories form the basis for the offers associated with the particular demographic and from which a particular offer and/or advertising message may be selected for presentation to the on-line shopper of the moment.

The selected offer is communicated by the marketer, via a communications network to the on-line retailer and subsequently provided to the on-line shopper for consideration. The offer may be overtly made as a particular product identified as being suitable for consideration with the other contents of the shoppers cart, or may be provided as an advertisement inserted into the current display upon the on-line retailer's web pages.

As the analyses may be conducted in advance of the presence of the on-line shopper, extensive work may also be done to prepare for the interaction with that shopper. Advertising may be prepared to present the offer in a manner deemed most appropriate for the particular market demographic. The story of the product may be presented in a form tailored to appeal to those needs of the on-line shopper identified as associated with the particular product beyond focusing exclusively upon the consumer benefits of the product or category.

As an example, the on-line retailer may provide notice that a shopper has arrived at their site with the appearance of being the parent of a toddler (based upon past shopping history) as well as having an interest in organic products as well as products free from scents. This may trigger an offer from a marketer, communicated to the on-line retailer, and ultimately to the on-line shopper, related to infant care products, baby-wipes, shampoos, detergents, designed, or otherwise offering the benefit of being suitable for exposure to sensitive skin. Shoppers identified as new mothers may be presented with offers and information related to personal beauty products to assist them with concerns about their appearance. New parents may be presented offers coached in terms associated with the convenience of delivery to help with concerns about adjustments to their schedule due to infant care needs. New fathers may be presented offers related to shaving/grooming to address any concerns associated with contact with their new baby.

Shoppers browsing for powered toys or electronic devices may be presented offers associated with the appropriate batteries for the devices being considered. Shoppers considering any aspect of oral hygiene, i.e. toothbrushes, toothpaste, mouthwash, may be presented offers associated with complete oral care regimens including all of the above as well as whitening products, dental floss, and other regimen components. Shoppers considering bathing suit purchases may be presented offers and information related to hair removal products, epilators, razors, etc., as an aid to preparing for bathing suit season. Pet owners may be presented offers and information associated with cleaning products which are pet safe and effective. Shoppers identified as lingerie purchasers, or as shopping for lingerie may be presented offers and information related to feminine care and laundry products to assist in protecting and preserving their lingerie.

The selection of the offer/advertising message to be presented may be further tailored in instance where information relating to the actual on-line shopping cart of the shopper of the moment is also made available. This additional information may be categorized in terms of the consumer benefits and underlying consumer needs addressed by the contents of the cart. The identification of needs and benefits may provide insight into benefits and/or needs often addressed through the purchase of correlated basket product categories, yet unaddressed by the contents of the cart of the moment.

In instance where the contents of the on-line shopper's cart are accessible, the related market demographic memberships of the shopper may be determined according to those contents in place of, or in addition to the other sources of information about the on-line shopper described above. In such an instance, the shopping cart contents may be evaluated in terms of the aggregated basket data and the shopper of the moment may be identified as being a member of particular market demographics according to similarities between their shopping basket contents and the basket contents of previously identified market demographics.

This process may provide additional insights into which product offers may be most relevant and most successful with this particular shopper. The evaluation of the cart contents may yield a composite set of market demographics. Each market demographic within the set may have a unique set of consumer benefits and consumer needs associated with the respective demographic. The composite of demographics may have a composite set of needs and benefits as well as novel combinations of benefits and needs unassociated with each of the respective market demographic members of the composite set.

The marketer, or on-line retailer may undertake analysis of product categories and products to define consumer benefits associated with each product and/or category. Further analysis may be undertaken to determine the consumer needs met by the particular benefits as well as the needs which may possibly be met by the range of possibilities represented by the set of combinations of consumer benefits available through the set of products available via the retailer.

Consumer needs represented by prophetic combinations of market demographics may be evaluated and appropriate product combination offerings, together with relevant advertising messaging may be prepared for presentation when the previously prophetic on-line shopper becomes a reality.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

what is claimed is:

1. A method for presenting an offer, the method comprising steps of:
a. receiving, via a communications network, on-line shopping basket contents information associated with an on-line shopper;
b. analyzing the on-line shopping basket information according to the product market categories of the contents;
c. determining a market demographic from the analysis of the on-line shopping basket;
d. analyzing on-line and/or off-line shopping basket content information associated with the market demographic, according to a consumer benefit of a product market category of the content;
e. identifying a consumer need of the on-line shopper according to the consumer benefits; and
f. communicating, via an electronic communications network, information, associated with products or services related to the consumer need to the on-line shopper.

2. The method according to claim 1, wherein the step of identifying a consumer need of the on-line shopper comprises:
g. Identifying consumer benefits associated with the product market categories of the off-line and/or on-line shopping basket contents;
h. Identifying consumer needs addressed by the identified consumer benefits associated with the off-line and/or on-line shopping basket contents and by combinations of the consumer benefits associated with the off-line and/or on-line shopping basket contents; and
i. Identifying consumer needs addressed by identified consumer benefits and unaddressed by the on-line shopping basket contents.

3. The method according to claim 1, wherein the step of identifying a consumer need of the on-line shopper comprises:
g. Comparing the product market categories of the on-line shopping basket to the product market categories of an off-line shopping basket for the market demographic; and
h. Identifying product market categories associated with the off-line shopping basket of the market demographic and unassociated with the on-line shopping basket of the shopper.

4. The method according to claim 1 wherein the step of receiving on-line shopping basket contents information associated with an on-line shopper via a communications network, comprises receiving information from an on-line retailer.

5. The method according to claim 1 wherein the step of determining a market demographic of the on-line shopper further comprises an analysis of an on-line profile of the on-line shopper.

6. A method for presenting an offer, the method comprising steps of:
a. Receiving notice, via a communications network that a member of a particular market demographic is shopping on-line;
b. Analyzing on-line and/or off-line shopping basket content information associated with the market demographic, according to a consumer benefit of a product market category of the content;
c. Identifying a consumer need of the market demographic according to the consumer benefits; and
d. Communicating information, associated with products or services related to the consumer need, via an electronic communications network to the market demographic member.

7. The method according to claim 6, wherein the step of identifying a consumer need of the on-line shopper comprises:
j. identifying consumer benefits associated with the product market categories of the off-line and/or on-line shopping basket contents;
k. identifying consumer needs addressed by the identified consumer benefits associated with the off-line and/or on-line shopping basket contents and by combinations of the consumer benefits associated with the off-line shopping basket contents; and
l. identifying consumer needs addressed by the off-line shopping basket contents and unaddressed by the on-line shopping basket contents.

8. The method according to claim 6, wherein the step of identifying a consumer need of the on-line shopper comprises:
i. comparing the product market categories of the on-line shopping basket to the product market categories of an off-line shopping basket for the market demographic; and
j. identifying product market categories associated with the off-line shopping basket of the market demographic and unassociated with the on-line shopping basket of the shopper.

9. The method according to claim 6 wherein the step of receiving notice, via a communications network, that a member of a particular market demographic is shopping on-line, comprises receiving information from an on-line retailer.

10. The method according to claim 6, further comprising the step of: receiving information related to the shopping cart contents of the market demographic member.
